(19) United States
(12) Patent Application Publication
(10) Pub. No.: US 2026/0219876 A1
(43) Pub. Date: Jul. 30, 2026

(54) FIRMWARE UPDATE MANAGEMENT

(71) Applicant: Honeywell International Inc., Charlotte, NC (US)

(72) Inventors: Abinash Prusty, Bengaluru (IN); Amitsurjya Duttagupta, Noida (IN); Indranil Datta, Bengaluru (IN); Prem Prakas Kakkassery, Bengaluru (IN)

(21) Appl. No.: 19/041,126

(22) Filed: Jan. 30, 2025

(51) Int. Cl. G06F 8/65; G06F 9/4401

(52) U.S. Cl. CPC G06F 8/66; G06F 9/4403

(57) ABSTRACT

Devices, methods, and systems for firmware update management are described herein. One method includes generating by a remote computing device, an update package including a cryptographic filter and a firmware update, receiving, by a computing device, the update package from the remote computing device, retrieving, by a bootloader of the computing device, a unique identifier of the computing device, where the bootloader resides in read-only memory of the computing device, determining, by the bootloader, whether the computing device is included in a target device list processed by the cryptographic filter using the unique identifier of the computing device, and causing, by the computing device, firmware of the computing device to be updated via the firmware update in response to the computing device being included in the target device list.

### TECHNICAL FIELD

The present disclosure relates generally to devices, methods, and systems for firmware update management.

### BACKGROUND

A computing device can utilize firmware in order to instruct execution of tasks by the computing device. Firmware can be, for example, instructions that are executable by a processing resource in order to cause the computing device to perform various tasks. Such tasks can include, for instance, controlling the functions of various hardware systems associated with the computing device.

Firmware can exist in different versions. A version can be a specific release or iteration of firmware in a particular state. In some instances, the firmware can be updated from an initial version to an updated version.

### BRIEF DESCRIPTION OF THE DRAWINGS

FIG. 1 illustrates a block diagram of an example of a system for firmware update management in accordance with one or more embodiments.

FIG. 2 illustrates an example of a cryptographic filter for firmware update management in accordance with one or more embodiments.

FIG. 3 illustrates an example of a computing device receiving an update package in accordance with one or more embodiments.

FIG. 4 illustrates an example of a method for firmware update management in accordance with one or more embodiments.

FIG. 5 is an example of a computing device for firmware update management in accordance with one or more embodiments.

### DETAILED DESCRIPTION

Devices, methods, and systems for firmware update management are described herein. One method includes generating by a remote computing device, an update package including a cryptographic filter and a firmware update, receiving, by a computing device, the update package from the remote computing device, retrieving, by a bootloader of the computing device, a unique identifier of the computing device, where the bootloader resides in read-only memory of the computing device, determining, by the bootloader, whether the computing device is included in a target device list processed by the cryptographic filter using the unique identifier of the computing device, and causing, by the computing device, firmware of the computing device to be updated via the firmware update in response to the computing device being included in the target device list.

As mentioned above, firmware can exist in different version states. While firmware may be initially released as a first version, the firmware may be updated at a later time to a second version. The firmware can be updated for a number of reasons. For example, the firmware may be updated in order to address glitches (e.g., bugs) in the firmware, to update security by fixing vulnerabilities in the firmware, to enhance performance of the firmware (e.g., by optimizing hardware performance, reducing power consumption, and/or speeding up processing), adding new features to the firmware, etc.

In some examples, a firmware update may be applicable to an entire population of computing devices. However, updating all of the computing devices in the population uniformly may not be desirable. For example, uniform distribution of the firmware update to an entire population of computing devices can utilize a large amount of bandwidth in an over the air (OTA) update distribution method. In addition to unnecessary bandwidth usage, uniform firmware update distribution can be a risk and lead to potential computing device downtime if certain computing devices in the population are not ready to receive the firmware update.

Firmware update management according to the disclosure can allow for selective firmware updates to certain computing devices in a population of computing devices by utilizing cryptographic filters and unique identifiers to ensure privacy, efficiency, and device security and performance. For example, an update package can be created to target certain computing devices in a population for an update. The update package can include a firmware update and a cryptographic filter. The cryptographic filter can process a target device list having unique identifiers associated with computing devices that are targeted for the firmware update. While the update package can be sent to more computing devices than those in the target device list, those computing devices that are in the target device list can perform the firmware update while other computing devices that are not in the target device list may not.

For example, each computing device that receives the update package can determine whether it is included in the target device list. A computing device that receives the update package can utilize a unique identifier stored in read-only memory in the computing device, determine whether the computing device is included in the target device list via the cryptographic filter using the unique identifier, and if so, perform the firmware update.

Firmware update management can accordingly provide a scalable, memory efficient approach for selective firmware updates. For example, firmware updates may be targeted at computing devices based on their geographic locations, device types and/or models, operational statuses, and/or licensure status of computing devices and/or associated components, etc. while promoting resource (e.g., memory and/or bandwidth) efficiency and ensuring device identifiers are protected from exposure, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

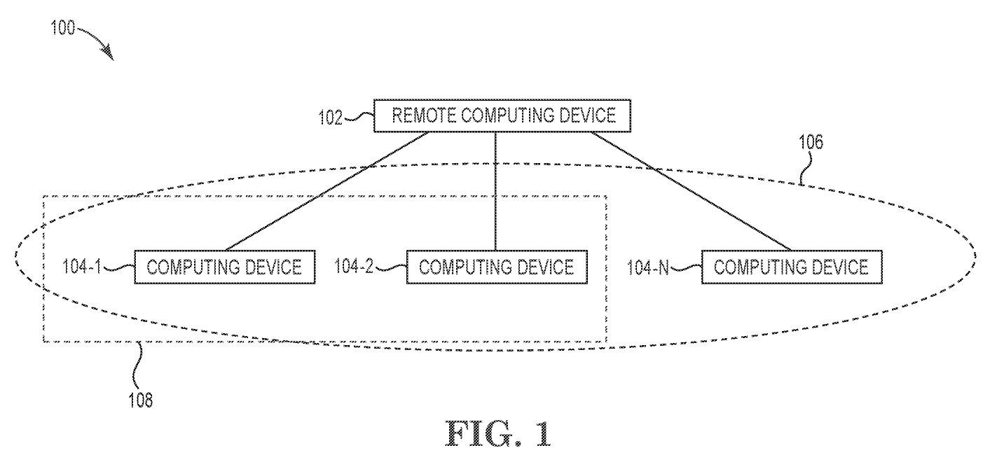

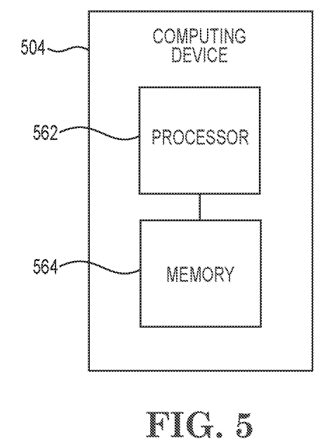

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 504 in FIG. 5.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 illustrates a block diagram of an example of a system 100 for firmware update management in accordance with one or more embodiments. The system 100 can include a remote computing device 102, computing devices 104-1, 104-2, 104-N, a population 106 of computing devices, and a subset 108 of the population 106 of the computing devices.

As mentioned above, a remote computing device 102 can allow for targeted firmware updates for certain computing devices 104 within the population 106 (e.g., a number) of computing devices 104. For example, firmware updates may be targeted at certain computing devices 104 based on their geographic locations, device types and/or models, operational statuses, and/or licensure status of computing devices and/or associated components, etc.

As used herein, the term “computing device” refers to an electronic system having a processing resource, memory resource, and/or an application-specific integrated circuit (ASIC) that can process information. Examples of computing devices can include, for instance, a laptop computer, a notebook computer, a desktop computer, an All-In-One (AIO) computing device, networking equipment (e.g., router, switch, etc.), and/or a mobile device, among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

In some examples, the computing devices 104 can be part of an Internet-of-Things (IoT) ecosystem. For example, the population 106 of computing devices 104 can be interconnected IoT devices. Accordingly, in some examples, the population 106 of computing devices 104 can communicate with each other and/or exchange data.

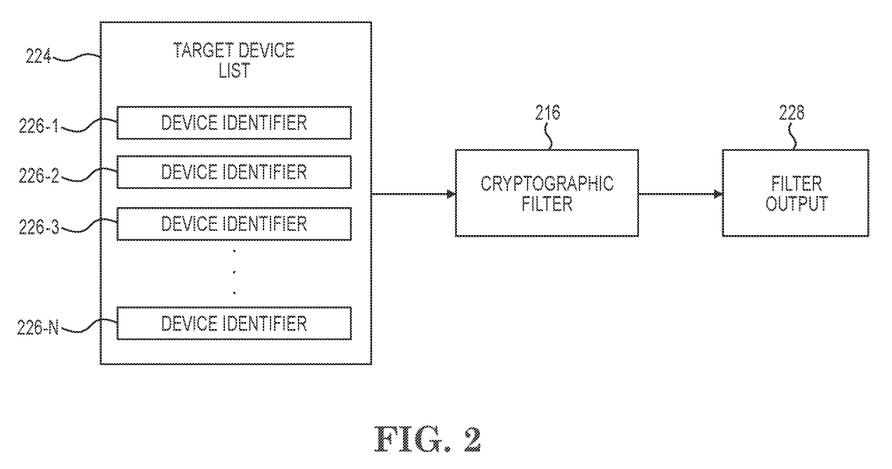

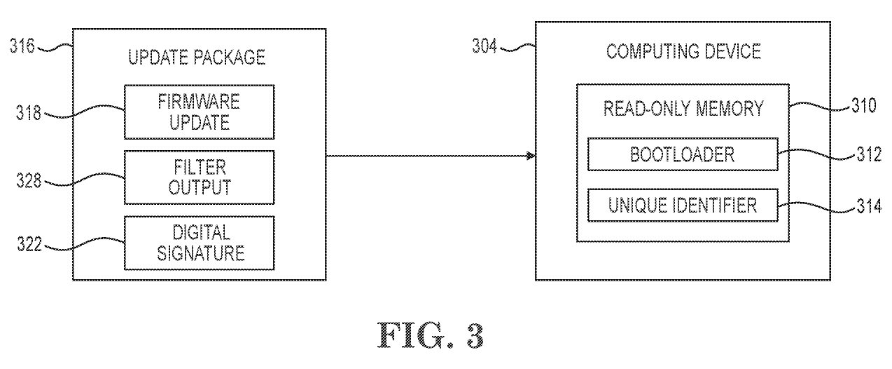

As illustrated in the system 100 of FIG. 1, the remote computing device 102 can be remotely located from the computing devices 104. In some examples, the remote computing device 102 can be a computing device included as part of a cloud-computing environment. For instance, the remote computing device 102 can be a computing device operating as part of a cloud computing environment remotely located from the computing devices 104 and can generate an update package including at least a firmware update and a cryptographic filter, as is further described in connection with FIG. 2. The remote computing device 102 can transmit the update package to the computing devices 104 in order to target a subset 108 of the population 106 of computing devices 104 for the firmware update, and the subset 108 of the computing devices 104 can utilize the update package to update firmware for the computing devices 104 included in the subset 108, as is further described in connection with FIG. 3.

As mentioned above, the population 106 of computing devices 104 can receive an update package from the remote computing device 102 including a cryptographic filter and a firmware update. Computing device 104-1 can retrieve a unique identifier of the computing device 104-1 and determine whether computing device 104-1 is included in a target device list processed by the cryptographic filter using the retrieved unique identifier. As the computing devices 104-1, 104-2 are to be included in the target device list but computing device 104-N is not, computing device 104-1 can cause its firmware to be updated via the firmware update in response to the computing device 104-1 being included in the target device list. Computing device 104-2 can perform the same procedure described above and cause its firmware to be updated via the firmware update in response to the computing device 104-2 being included in the target device list. However, as mentioned above, since computing device 104-N is not included in the target device list, computing device 104-N can also perform the same procedure but does not cause its firmware to be upgraded, as is further described in connection with FIG. 3.

FIG. 2 illustrates an example of a cryptographic filter 216 for firmware update management in accordance with one or more embodiments. A remote computing device can generate an update package including the cryptographic filter 216, as is further described herein.

As previously mentioned in connection with FIG. 1, a remote computing device (e.g., remote computing device 102, previously described in connection with FIG. 1) can generate an update package utilizing a cryptographic filter 216.

As used herein, a cryptographic filter refers to a data structure used to test whether a value is in a set. A cryptographic filter 216 can store hashed representations of an item (e.g., a device identifier) in a set, rather than the item itself. For example, a cryptographic filter 216 can store a hashed device identifier 226 instead of the actual device identifier itself. Therefore, a cryptographic filter 216 can be a space-efficient data structure that can be more memory efficient as compared to a standard data table. Accordingly, utilizing the cryptographic filter 216, as opposed to a standard data table, can help promote resource efficiency by reducing memory and bandwidth consumption associated with transmitting update packages to computing devices in a population, as compared with previous approaches.

The remote computing device can begin to generate the update package by selecting a cryptographic filter from a number of cryptographic filters. Cryptographic filters can include, for instance, Bloom filters, Cuckoo filters, or other types of cryptographic filters. A Bloom filter may be useful as items can be efficiently inserted into a Bloom filter and it has lower resource costs (e.g., processing, memory) when performing lookups. A Cuckoo filter may be useful as a Cuckoo filter can utilize smaller memory space as compared to a Bloom filter with high performance.

The remote computing device can select the type of cryptographic filter (e.g., Bloom, Cuckoo, or others) based on the type of computing devices to receive a firmware update and/or the volume of computing devices to receive a firmware update. As one example described herein, the remote computing device can select the Bloom filter. However, examples are not limited to the Bloom filter. For instance, the remote computing device can select the Cuckoo filter or other cryptographic filter types and perform the same method as is further described herein.

The remote computing device can begin to generate the update package by initializing the cryptographic filter 216 (e.g., the Bloom filter). For example, the remote computing device can define the parameters and initial state of the cryptographic filter 216, specifying criteria the cryptographic filter can use to select or reject certain values based on predefined conditions.

The remote computing device can generate the target device list 224. As used herein, a target device list refers to a list of computing devices that are intended to have their firmware updated. As previously mentioned above, the target device list 224 can target a predefined subset of computing devices out of a population of computing devices. The subset of computing devices for a firmware update may be targeted out of a total population of computing devices based on their geographic locations, device types and/or models, operational statuses, and/or licensure status of computing devices and/or associated components, etc.

In some examples, the target device list 224 can include devices having a particular licensure status. In some examples, the particular licensure status can refer to computing devices having particular licensed components (e.g., software and/or hardware) such that the target device list 224 includes those computing devices having those particular licensed components. In some examples, the particular licensure status can refer to computing devices falling under particular licensing agreements so that the target device list 224 includes those computing devices having paid (e.g., monetarily) for firmware upgrades whereas those computing devices that have not paid are not in the target device list 224. Generating the target device list 224 based on computing devices having a particular licensure status can ensure that the firmware update process remains cost-efficient and compliant with licensing terms, avoiding unnecessary expenses and potential legal issues.

In some examples, the target device list 224 can include devices in a particular geographic location. For example, the target device list 224 can be generated to include computing devices located in the European Union, whereas devices located in the United States are not included in the target device list 224. Additionally, while the geographic regions mentioned in the above example are large, embodiments are not so limited. For example, the geographic locations can be defined so that devices located in a particular state, region within a state, and/or devices in any other defined geographic area can be included in the target device list 224 whereas devices outside of the defined geographic area are not included in the target device list 224.

In some examples, the target device list 224 can include devices of a particular device type and/or model. For example, the target device list 224 can be generated to include computing devices that are mobile devices, (e.g., laptops, mobile phones, etc.), whereas computing devices that are not mobile devices (e.g., desktops, servers, etc.) are not included in the target device list 224. As another example, the target device list 224 can be generated to include devices that are smart appliances, whereas other devices such as medical devices/industrial automation/automotive devices are not included in the target device list 224. As a further example, the target device list 224 can be generated to include devices of a particular model (e.g., smart appliance model B), whereas other devices that are similar but a different model (e.g., smart appliance model A) are not included in the target device list 224.

In some examples, the target device list 224 can include devices having a particular operational status. For example, the target device list 224 can be generated to include computing devices that are online (e.g., connected to the Internet) and/or meet certain performance metrics (e.g., devices having certain bandwidth speeds, devices having particular amounts of memory/processing power, etc.) Additionally, while the target device list 224 can be generated to include computing devices that are online, embodiments are not so limited. For example, the target device list 224 can be generated to include computing devices that are offline (e.g., not connected to the Internet).

The remote computing device can populate the target device list 224 by compiling the device identifiers of each computing device intended to receive a firmware update. For example, the remote computing device can include a database of unique identifiers of each computing device in the population of computing devices. Such unique identifiers may include a serial number, media access control (MAC) address, among other examples of unique device identifiers.

As previously described in connection with FIG. 1, the population of computing devices may include computing device 1, computing device 2, and computing device 3. The computing device 1 may include a unique identifier associated with computing device 1 (e.g., “001”), the computing device 2 may include a unique identifier associated with computing device 2 (e.g., “002”), and the computing device 3 may include a unique identifier associated with computing device 3 (e.g., “003”) that the remote computing device stores in a database. The remote computing device can insert the unique identifier for computing device 1 into the cryptographic filter 216 as device identifier 226-1. Additionally, the remote computing device can insert the unique identifier for computing device 2 into the cryptographic filter 216 as device identifier 226-2. The remote computing device can repeat this process for all of the device identifiers 226 to populate the target device list 224. The device identifiers 226 can comprise the target device list 224. However, as mentioned above, the remote computing device can refrain from inserting the unique identifiers for computing devices not included in the target device list, as it is not intended that all computing devices in the population are to receive the firmware update. Rather, just a subset of the population are to receive the firmware update.

Once the target device list 224 is populated, the remote computing device can provide the target device list 224 to the cryptographic filter 216. The cryptographic filter 216 can process the target device list 224 and generate a filter output 228. For example, the cryptographic filter 216 can compute hashes for each of the device identifiers 226 included in the target device list. The filter output 228 can include the hashed device identifiers from the target device list 224.

FIG. 3 illustrates an example of a computing device 304 receiving an update package 320 in accordance with one or more embodiments. The remote computing device can generate the update package 320 utilizing the filter output 328 as previously described in connection with FIG. 2. For example, the remote computing device can generate the update package 320 by generating the target device list and providing the target device list to the cryptographic filter. Additionally, the remote computing device can further generate the update package 320 by including the firmware update 318 and a digital signature 322 in the update package 320, as is further described herein.

As illustrated in FIG. 3, the update package 320 can include a firmware update 318, the filter output 328, and a digital signature 322. An update package, as used herein, refers to a collection of files and/or instructions for installation and/or configuration of firmware. For example, the update package 320 can be a collection of files to effect a firmware update for a subset of a population of computing devices.

The remote computing device can generate the update package 320 by including the firmware update 318 in the update package 320. As described herein, the firmware update is a modification of instructions executable by a processing resource to cause a computing device to perform various tasks. For example, a firmware update can be intended to modify firmware of a device/component of a device from a current version to an updated version. Such an update may be performed in order to address glitches (e.g., bugs) in the firmware, to update security by fixing vulnerabilities in the firmware, to enhance performance of the firmware (e.g., by optimizing hardware performance, reducing power consumption, and/or speeding up processing), adding new features to the firmware, etc.

Additionally, the remote computing device can generate a digital signature 322. A digital signature, as used herein, refers to a signature generated via a private key to authenticate a source of a sender. For example, the digital signature 322 can include data encrypted by a private key associated with the remote computing device. A computing device receiving the update package 320 can utilize a public key in order to decrypt the digital signature 322 to verify the source of the update package 320 is the remote computing device.

Accordingly, the remote computing device can transmit the update package 320 to a number of computing devices (e.g., a population of computing devices). The devices included in the target device list (e.g., the subset of computing devices which are targeted for a firmware update) in the filter output 328 can be included in the population of computing devices the update package 320 is transmitted to. Each computing device of the population of computing devices can then determine whether they are included in the target device list, cause a firmware update to occur if so, or refrain from updating the firmware if not, as is further described herein.

The computing device 304 can receive the update package 320 from the remote computing device. As illustrated in FIG. 3 (and previously described above), the update package 320 can include the firmware update 318, the filter output 328, and a digital signature 322.

The computing device 304 can first verify the digital signature 322. The computing device 304 can utilize the digital signature to verify the source of the update package 320 is the remote computing device, and not some other illegitimate source. In order to verify the digital signature 322, the computing device 304 can utilize a public key to verify the digital signature 322. If the computing device 304 is not able to verify the digital signature 322 with the public key, the computing device 304 can stop the firmware update process, as this indicates the update package 320 may not be legitimate (e.g., has been tampered with, comes from an illegitimate source, etc.) However, if the computing device 304 is able to verify the digital signature 322 with the public key, the computing device 304 can proceed with the firmware update process if the computing device 304 is included in the target device list, as is further described herein.

To begin the firmware update process, the computing device 304 can retrieve a unique identifier of the computing device 304 from read-only memory 310 of the computing device 304 in response to the digital signature 322 being verified with the public key. The computing device 304 can utilize a bootloader 312 to retrieve the unique identifier. As used herein, a bootloader is a computer program that is responsible for booting a computing device. For example, the bootloader 312 can load relevant operating system data into a main memory of the computing device 304.

As illustrated in FIG. 3, the bootloader 312 can reside in the read-only memory 310 of the computing device 304. The bootloader 312 can operate from the read-only memory 310, ensuring integrity and reliability. Since the bootloader 312 is stored in read-only memory 310, the bootloader 312 cannot be modified, ensuring security as compared with previous approaches that do not utilize a bootloader stored in immutable read-only memory.

In examples described herein, the bootloader 312 can retrieve the unique identifier 314 of the computing device 304 from the read-only memory 310. As previously mentioned in FIG. 1, the unique identifier 314 can be an identification number that uniquely identifies the computing device 304. Examples of the unique identifier 314 for the computing device 304 can include a serial number, MAC address, or other unique identification number. The bootloader 312 can retrieve the unique identifier 314, such as a serial number of the computing device 304, from the read-only memory 310.

In some examples, the bootloader 312 can retrieve the unique identifier from the read-only memory 310 in response to the computing device 304 performing a boot procedure. A boot procedure can refer to a computing device being powered on, its hardware components being initialized, a self-test being run to check for hardware functionality, and/or the operating system being loaded. In some examples, the bootloader 312 can retrieve the unique identifier from the read-only memory 310 at a point during the boot procedure of the computing device 304.

In some examples, the computing device 304 can compute a hash of the unique identifier 314. For example, the computing device 304 can compute a hash of the serial number of the computing device 304 (e.g., in the example in which the unique identifier 314 is a serial number).

However, embodiments of the disclosure are not so limited. For example, the computing device 304 does not have to compute the hash of the unique identifier 314. For example, the computing device 304 can utilizing the unique identifier 314 itself. The unique identifier 314 can allow the bootloader 312 to determine whether the computing device 304 is in the target device list, as is further described herein.

Accordingly, the bootloader 312 can determine whether the computing device 304 is in the target device list included in the filter output 328. For example, the bootloader 312 can compare the unique identifier 314 to the number of hashed device identifiers included in the target device list in the filter output 328. As mentioned above, the target device list includes unique hashed device identifiers for computing devices intended to receive the firmware update.

In response to the unique identifier 314 matching a hashed device identifier of the number of hashed device identifiers in the target device list in the cryptographic filter 316, the bootloader 312 can cause the firmware of the computing device 304 to be updated. For example, in response to the serial number of the computing device 304 matching a serial number included in the target device list in the filter output 328 in the update package 320 generated by the remote computing device, the bootloader 312 can cause firmware of the computing device 304 to be updated. The bootloader 312 can utilize the firmware update 318 included in the update package 320 to update the firmware of the computing device 304 in order to address glitches (e.g., bugs) in the firmware, to update security by fixing vulnerabilities in the firmware, to enhance performance of the firmware (e.g., by optimizing hardware performance, reducing power consumption, and/or speeding up processing), adding new features to the firmware, among other reasons to update the firmware of the computing device 304.

As previously mentioned above, the update package 320 can be transmitted to an entire population of computing devices, where the firmware update 318 in the update package 320 is intended only for a subset of the computing devices in the population (e.g., those devices included in the target device list). Accordingly, in an example in which the computing device 304 is not in the target device list, the bootloader 312 can compare the unique identifier 314 to the number of hashed identifiers included in the target device list in the filter output 328. In response to the unique identifier 314 not matching a hashed device identifier of the number of hashed device identifiers in the target device list in the cryptographic filter 316, the bootloader 312 can prevent the firmware of the computing device 304 from being updated.

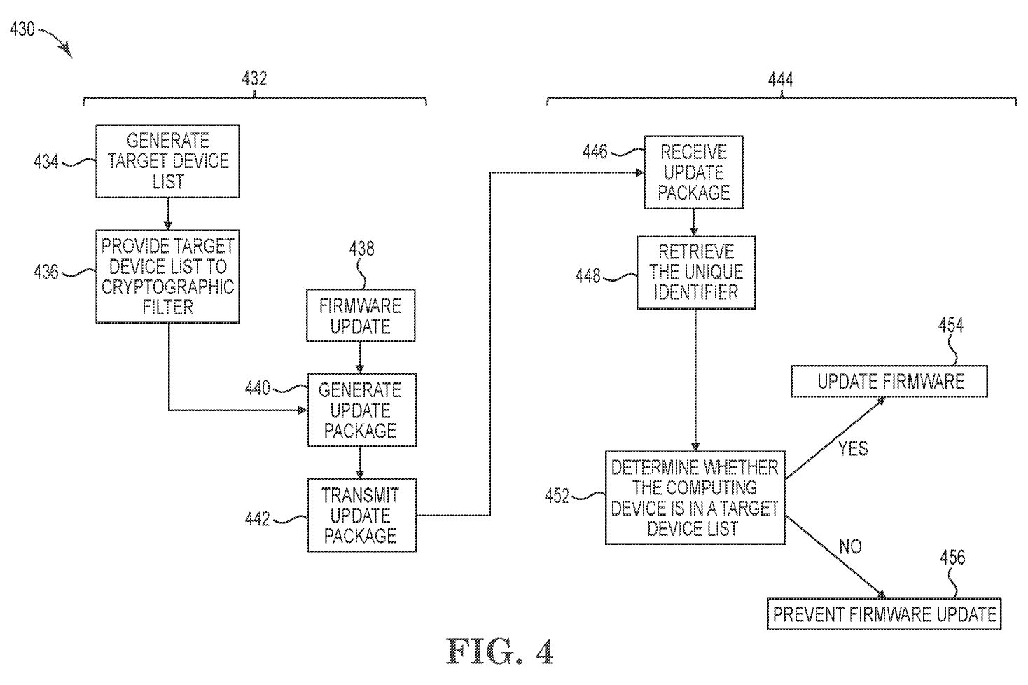

FIG. 4 illustrates an example of a method 430 for firmware update management in accordance with one or more embodiments. The method 430 can be performed by, for example, remote computing device 102 and computing devices 104 of the distributed computing environment, previously described in connection with FIG. 1.

As previously described above, the method 430 can include generating an update package. The steps 432 (comprising method steps 434 through 442) can be performed by, for example, a remote computing device.

At 434, the method 430 includes generating a target device list. The target device list can include a list of computing devices that are intended to have their firmware updated. The target device list can target a predefined subset of computing devices out of a population of computing devices. The subset of computing devices for a firmware update may be targeted out of a total population of computing devices based on their geographic locations, device types and/or models, operational statuses, and/or licensure status of computing devices and/or associated components, etc.

Generating the target device list 434 can include populating the target device list with unique device identifiers associated with the computing devices intended to have their firmware updated. For example, if the population of computing devices includes 1,000 computing devices, and a subset of 300 of the 1,000 computing devices are intended to have their firmware updated, the remote computing device can insert each unique identifier for each computing device of the subset of 300 devices in the target device list.

At 436, the method 430 includes providing the target device list to a cryptographic filter. The cryptographic filter can process the target device list by computing hashes for each of the device identifiers included in the target device list, and generate a filter output.

At 440, the method 430 includes generating the update package. For example, the remote computing device can receive the firmware update 438 to be transmitted to the subset of 300 computing devices to update the firmware of the 300 computing devices. The remote computing device can generate the update package by including the firmware update, the filter output (including the processed target device list), and a digital signature (generated by the remote computing device using a private key). Lastly, at 442, the method 430 includes transmitting, by the remote computing device, the update package to the entire population of computing devices, including the subset of computing devices.

As previously described above, the method 430 can include causing a computing device to update its firmware. The steps 444 (comprising method steps 446 through 456) can be performed by, for example, each computing device in the population of computing devices. If the computing device is included in the subset (e.g., is included in the target device list), the computing device can update its firmware, as is further described herein.

At 446, the method 430 includes receiving, by a computing device, an update package. As previously mentioned, the update package can include a firmware update, a filter output, and a digital signature.

At 448, the method 430 includes retrieving, by a bootloader residing in read-only memory of the computing device, the unique identifier of the computing device. The unique identifier can be, for example, a serial number of the computing device, among other examples of unique identifiers.

In some examples, the method 430 can include computing a hash of the unique identifier. For example, the computing device can compute a hash of the serial number of the computing device. The computing device can compute the hash of the unique identifier in a same manner as how the remote computing device generated the hashed device identifiers for devices to be included in the target device list in the cryptographic filter.

At 452, the method 430 includes determining whether the computing device is in the target device list included in the cryptographic filter. For example, the bootloader can compare the unique identifier (or optionally, the computed hash of the unique identifier) of the computing device to the number of hashed device identifiers included in the target device list.

At 454, the bootloader can cause the computing device to update its firmware in response to the unique identifier of the computing device matching a hashed device identifier of the number of hashed device identifiers in the target device list. However, at 456, the bootloader can prevent the computing device from updating its firmware in response to the unique identifier of the computing device not matching a hashed device identifier of the number of hashed device identifiers in the target device list.

As previously mentioned above, in some examples, a firmware update may be intended to be applied to devices having a particular licensure status. The licensure status may include certain computing devices of a particular model having a predefined license agreement. Accordingly, while the population of computing devices may be a model of mobile phone, a subset of the population of mobile phones may include this predefined license agreement and as such, may be targeted for a firmware update in order to, for instance, add a particular feature to the mobile phones.

In order to effectuate this update, the remote computing device can select a Cuckoo filter and generate a target device list at 434 including those mobile devices falling under the license agreement to update the firmware of those mobile devices to add the new feature. At 436, the remote computing device can provide the target device list to the cryptographic filter to generate a filter output. At 440, the remote computing device can generate the update package including the firmware update from 438, the filter output (including the target device list), and a digital signature, and transmit the update package at 442 to the population of mobile devices.

At 446, each mobile device in the population of mobile devices can receive the update package. In one example, a mobile device not under the license agreement can receive the update package at 446. A bootloader of such a mobile device can retrieve a unique identifier of the mobile device at 448 from read-only memory and determine whether the mobile device is in the target device list in the update package at 452 by comparing the unique identifier of the mobile device to the number of hashed device identifiers included in the target device list. As this mobile device is not under the licensing agreement, this mobile device’s unique device identifier is not in the target device list, and as such, the bootloader does not find a match of the unique device identifier in the number of hashed device identifiers included in the target device list. Accordingly, at 456, the bootloader of the mobile device can prevent the firmware update.

Continuing with the example from above, a mobile device that is under the license agreement can also receive the update package at 446. A bootloader of such a mobile device can retrieve a unique identifier of the mobile device at 448 from read-only memory and determine whether the mobile device is in the target device list in the update package at 452 by comparing the unique device identifier of the mobile device to the number of hashed device identifiers included in the target device list. As this mobile device is under the licensing agreement, this mobile device’s unique device identifier is in the target device list, and as such, the bootloader can find a match of the unique device identifier in the number of hashed device identifiers included in the target device list. Accordingly, at 454, the bootloader of the mobile device can cause the firmware of the mobile device to be updated to include the new feature intended for the subset of the population of mobile devices according to the license agreement.

As another example, a firmware update may be intended to be applied to devices in a particular geographic location. For example, smart appliances may be sold in the European Union and in the United States. The smart appliances in the European Union may have an intended firmware update, which is not applicable to those smart appliances in the United States. Accordingly, the population of devices may include all of the smart appliances sold in both the European Union and the United States, while a subset of the population of smart appliances may be those smart appliances in the European Union only. Those smart appliances located in the European Union may be targeted for the firmware update.

In order to effectuate this update, the remote computing device can select a Bloom filter and generate a target device list at 434 including those smart appliances located in the European Union to update the firmware of the smart appliances located in the European Union. At 436, the remote computing device can provide the target device list to the cryptographic filter to generate a filter output. At 440, the remote computing device can generate the update package including the firmware update from 438, the filter output (including the target device list), and a digital signature, and transmit the update package at 442 to the population of smart appliances.

At 446, each smart appliance in the population of smart appliances can receive the update package. In one example, a smart appliance located in the United States can receive the update package at 446. A bootloader of a smart appliance located in the United States can retrieve a unique identifier of the smart appliance at 448 from read-only memory and determine whether the smart appliance is in the target device list in the update package at 452 by comparing the unique device identifier of the smart appliance to the number of hashed device identifiers included in the target device list. As this smart appliance is not located in the European Union, this smart appliance’s unique device identifier is not in the target device list, and as such, the bootloader does not find a match of the unique device identifier in the number of hashed device identifiers included in the target device list. Accordingly, at 456, the bootloader of the smart appliance in the United States can prevent the firmware update.

Continuing with the example from above, a smart appliance located in the European Union can also receive the update package at 446. A bootloader of such a smart appliance located in the European Union can retrieve a unique identifier of the smart appliance at 448 from read-only memory and determine whether the smart appliance is in the target device list in the update package at 452 by comparing the unique device identifier of the smart appliance to the number of hashed device identifiers included in the target device list. As this smart appliance is located in the European Union, this smart appliance’s unique device identifier is in the target device list, and as such, the bootloader can find a match of the unique device identifier of the unique identifier in the number of hashed device identifiers included in the target device list. Accordingly, at 454, the bootloader of the smart appliance can cause the firmware of the smart appliance to be updated.

As another example, a firmware update may be intended to be applied to medical devices. As interconnected medical devices require strict security and compliance measures for updates, firmware update management according to the disclosure can allow for such updates to occur, as use of cryptographic filters and secure bootloader in read-only memory (e.g., immutable storage) ensure unauthorized access to firmware updates and device identities.

Interconnected medical devices may include devices of different types. A first type of medical device may have an intended firmware update, which is not applicable to the second type of medical device. Accordingly, the population of devices may include all of the interconnected medical devices, while a subset of the population of medical devices may be those medical devices of the first type only. Those medical devices of the first type may be targeted for the firmware update.

In order to effectuate this update, the remote computing device can select a Bloom filter and generate a target device list at 434 including those medical devices of the first type to update the firmware of those medical devices of the first type. At 436, the remote computing device can provide the target device list to the cryptographic filter to generate a filter output. At 440, the remote computing device can generate the update package including the firmware update from 438, the filter output (including the target device list), and a digital signature, and transmit the update package at 442 to the population of medical devices (both first type and second type).

At 446, each medical device in the population of medical devices can receive the update package. In one example, a medical device of the second type can receive the update package at 446. A bootloader of a medical device of the second type can retrieve a unique identifier of the medical device at 448 from read-only memory and determine whether the medical device is in the target device list in the update package at 452 by comparing the unique identifier of the medical device to the number of hashed device identifiers included in the target device list. As this medical device is of the second type and not of the first type, this medical device’s unique device identifier is not in the target device list, and as such, the bootloader does not find a match of the unique device identifier in the number of hashed device identifiers included in the target device list. Accordingly, at 456, the bootloader of the medical device of the second type can prevent the firmware update.

Continuing with the example from above, a medical device of the first type can also receive the update package at 446. A bootloader of the medical device of the first type can retrieve a unique identifier of the medical device at 448 from read-only memory and determine whether the medical device is in the target device list at 452 by comparing the unique device identifier of the medical device to the number of hashed device identifiers included in the target device list. As this medical device is of the first type, this medical device’s unique device identifier is in the target device list, and as such, the bootloader can find a match of the unique device identifier in the number of hashed device identifiers included in the target device list. Accordingly, at 454, the bootloader of the medical device of the first type can cause the firmware of the medical device to be updated.

Accordingly, firmware update management as described herein can allow for a secure, memory efficient approach for selective firmware updates. For example, firmware updates can be transmitted to population subsets based on their geographic locations, device types and/or models, operational statuses, and/or licensure status of computing devices and/or associated components, etc. Such an approach can allow for cost-effective license management by updating firmware of devices with proper licenses, differentiating between free and paid upgrades, and avoiding potential legal issues. Additionally, use of cryptographic filters and bootloaders residing in secure read-only memory can provide enhanced security and privacy, reducing exposure to potential bad actors and the threat of device identities being released, as compared to previous approaches. Further, firmware update management can promote computing resource optimization and efficiency, reducing bandwidth and memory usage as compared to previous approaches.

FIG. 5 is an example of a computing device 504 for firmware update management in accordance with one or more embodiments. As illustrated in FIG. 5, the computing device 504 can include a memory 564 and a processor 562 for firmware update management, in accordance with the present disclosure.

The memory 564 can be any type of storage medium that can be accessed by the processor 562 to perform various examples of the present disclosure. For example, the memory 564 can be a non-transitory computer readable medium having computer readable instructions (e.g., executable instructions/computer program instructions) stored thereon that are executable by the processor 562 for firmware update management in accordance with the present disclosure.

The memory 564 can be volatile or nonvolatile memory. The memory 564 can also be removable (e.g., portable) memory, or non-removable (e.g., internal) memory. For example, the memory 564 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 564 is illustrated as being located within computing device 504, embodiments of the present disclosure are not so limited. For example, memory 564 can also be located internal to another computing resource (e.g., enabling computer readable instructions to be downloaded over the Internet or another wired or wireless connection).

The processor 562 may be a central processing unit (CPU), a semiconductor-based microprocessor, and/or other hardware devices suitable for retrieval and execution of machine-readable instructions stored in the memory 564.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for firmware update management, comprising:
generating, by a remote computing device, an update package including a cryptographic filter and a firmware update;
receiving, by a computing device, the update package from the remote computing device;
retrieving, by a bootloader of the computing device, a unique identifier of the computing device, wherein the bootloader resides in read-only memory of the computing device;
determining, by the bootloader, whether the computing device is included in a target device list processed by the cryptographic filter using the unique identifier of the computing device; and
causing, by the computing device, firmware of the computing device to be updated via the firmware update in response to the computing device being included in the target device list.

2. The method of claim 1, wherein the method includes retrieving the unique identifier from the read-only memory of the computing device.

3. The method of claim 1, wherein the method includes computing, by the computing device, a hash of the unique identifier of the computing device.

4. The method of claim 3, wherein the method includes determining whether the hash of the unique identifier is included in the target device list by comparing the hash of the unique identifier of the computing device to a number of hashed device identifiers associated with devices in the target device list intended to receive the firmware update.

5. The method of claim 4, wherein the method includes:
causing, in response to the hash of the unique identifier of the computing device matching a hashed device identifier of the number of hashed device identifiers, the firmware of the computing device to be updated; and
preventing, in response to the hash of the unique identifier of the computing device not matching a hashed device identifier of the number of hashed device identifiers, the firmware of the computing device from being updated.

6. The method of claim 1, wherein the method includes generating, by the remote computing device, the update package by generating the target device list.

7. The method of claim 6, wherein the method includes generating, by the remote computing device, the target device list to include devices having a particular licensure status.

8. The method of claim 6, wherein the method includes generating, by the remote computing device, the target device list to include devices of a particular device type.

9. The method of claim 6, wherein the method includes generating, by the remote computing device, the target device list to include devices in a particular geographic location.

10. The method of claim 1, wherein the method includes transmitting, by the remote computing device, the update package to a number of computing devices, wherein devices included in the target device list are a subset of the number of computing devices.

11. The method of claim 1, wherein generating the update package includes selecting, by the remote computing device, a cryptographic filter from a number of cryptographic filters.

12. A computing device for firmware update management, comprising:
a processing resource; and
a memory resource storing non-transitory machine-readable instructions to cause the processing resource to:
receive an update package including a cryptographic filter and a firmware update;
retrieve, by a bootloader of the computing device, a unique identifier of the computing device from read-only memory of the computing device;
compute a hash of the unique identifier;
determine whether the computing device is included in a target device list processed by the cryptographic filter by comparing the hash to a number of hashed device identifiers in the target device list; and
cause firmware of the computing device to be updated via the firmware update in response to the hash matching a hashed device identifier of the number of hashed device identifiers in the target device list.

13. The computing device of claim 12, wherein the bootloader resides in the read-only memory.

14. The computing device of claim 12, wherein the cryptographic filter is a Bloom filter.

15. The computing device of claim 12, wherein the cryptographic filter is a Cuckoo filter.

16. The computing device of claim 12, wherein the processing resource is configured to retrieve the unique identifier of the computing device in response to the computing device performing a boot procedure.

17. A non-transitory computer readable medium storing instructions executable by a processing resource to cause the processing resource to:
receive, from a remote computing device, an update package including a cryptographic filter and a firmware update;
retrieve, by a bootloader, a unique identifier of a computing device from read-only memory of the computing device, wherein the bootloader resides in the read-only memory;
compute a hash of the unique identifier;
determine, by the bootloader, whether the computing device is included in a target device list processed by the cryptographic filter by comparing the hash to a number of hashed device identifiers in the target device list; and
cause firmware of the computing device to be updated via the firmware update in response to the hash matching a hashed device identifier of the number of hashed device identifiers in the target device list.

18. The non-transitory computer readable medium of claim 17, wherein the update package includes a digital signature.

19. The non-transitory computer readable medium of claim 18, comprising instructions to cause the processing resource to verify the package signature using a public key.

20. The non-transitory computer readable medium of claim 19, comprising instructions to cause the processing resource to retrieve the unique identifier in response to the package signature being verified.
